(19) United States
(12) Patent Application Publication
(10) Pub. No.: US 2024/0233728 A1
(43) Pub. Date: Jul. 11, 2024

(54) User Gestures to Initiate Voice Commands

(71) Applicant: Hewlett-Packard Development Company, L.P., Spring, TX (US)

(72) Inventor: Robert Campbell, Spring, TX (US)

(21) Appl. No.: 18/577,216

(22) PCT Filed: Jul. 30, 2021
(86) PCT No.: PCT/US2021/071078

§ 371 Date: Jan. 5, 2024

(51) Int. Cl. G10L 15/24; G06F 3/01; G10L 15/22; G10L 15/30; H04L 65/403

(52) U.S. Cl. CPC G10L 15/24; G06F 3/017; G10L 15/22; G10L 15/30; H04L 65/403; G10L 2015/223

(57) ABSTRACT

In an example implementation according to aspects of the present disclosure, a system comprising a gesture input device, an audio input device, and a processor communicatively coupled to the gesture input device and the audio input device. In this example, the processor receives, by the gesture input device, initiating gesture data performed by a user which indicates an initiation of a voice command. The processor further captures, by the audio input device, the voice command spoken the user and receives, by the gesture input device, terminating gesture data performed by the user which indicates a termination of the voice command.

### BACKGROUND

Computing systems accept a variety of inputs. Some computer applications detect gestures provided by input devices. A gesture typically has a shape, pose or movement associated with it. Such a gesture may be as simple as a stationary pose or a straight-line movement or as complicated as a series of movements or poses.

Other computer applications accept voice commands provided by input devices to control applications running on a device without the need to click a keyboard or mouse. A voice assistant keyword may be spoken to initiate the voice interaction using the voice commands. The keyword may be a word or a short phrase used to activate the voice assistance. The voice activation application may be continuously listening for the keyword.

### BRIEF DESCRIPTION OF THE DRAWINGS

Many aspects of the disclosure can be better understood with reference to the following drawings. While several examples are described in connection with these drawings, the disclosure is not limited to the examples disclosed herein.

FIG. 1 illustrates a block diagram of computing system 100 having instructions for initiating a voice command based on a gesture, according to an example;

FIG. 2 illustrates a flow diagram to operate an internet call computing system, according to an example;

FIG. 3 illustrates a block diagram of non-transitory storage medium 300 storing machine-readable instructions that, upon execution, cause a system to receive a voice command based on gesture data, according to an example;

FIG. 4 illustrates an operational architecture of a machine learning system to initiate a voice command based on a user gesture, according to another example;

FIG. 5 illustrates a sequence diagram to generate a voice command instruction based on a user gesture, according to another example; and

FIG. 6 is a block diagram of a computer system storing machine-readable instructions to initiate a voice command based on a user gesture, according to an example.

### DETAILED DESCRIPTION

Computing systems accept a variety of inputs. Some computer applications accept gestures provided by input devices to enable easier control and navigation of the applications. Gestures are ways to invoke an action, similar to clicking a toolbar button or typing a keyboard shortcut. Gestures may be performed with a pointing device (including but not limited to a mouse, stylus, hand and/or finger). A gesture typically has a shape, pose or movement associated with it. Such a gesture may be as simple as a stationary pose or a straight-line movement or as complicated as a series of movements or poses.

Other computer applications accept voice commands provided by input devices to control applications running on a device without the need to click a keyboard or mouse. A voice assistant keyword may be spoken to initiate the voice interaction using the voice commands. The keyword may be a word or a short phrase used to activate the voice recognition. The voice activation application may be continuously listening for the keyword

While activating the use of voice commands using a voice recognition keyword may work well in some user situations, in other situations it may not be ideal to use an audible alert to start listening for voice commands. For example, a user may want to use voice commands while on an internet call. In this situation, the user may not want to interrupt the internet call or notify the other users that the user is activating the use of voice commands. Instead, the user may desire to alert the computing device of an upcoming use of a voice command in an inaudible manner, have the internet call muted, and then use the voice commands to control or navigate an application.

In an example implementation according to aspects of the present disclosure, a system comprising a gesture input device, an audio input device, and a processor communicatively coupled to the gesture input device and the audio input device. In this example, the processor receives, by the gesture input device, initiating gesture data performed by a user which indicates an initiation of a voice command. The processor further captures, by the audio input device, the voice command spoken the user and receives, by the gesture input device, terminating gesture data performed by the user which indicates a termination of the voice command.

In another example, a method of operating an internet call system comprises detecting a user pose which indicates an activation of a voice recognition key. The method further includes muting the internet call to receive a voice command. Next, the method detects a release of the user pose which indicated a deactivation of a voice recognition key and, in response, unmutes the internet call.

In yet another example, a non-transitory computer readable medium comprises instructions executable by a processor to maintain gesture sequence data in a cloud-based data repository to be ingested by a machine learning system. The instructions detect a gesture sequence and query the machine learning system to determine that the gesture sequence data indicates an initiation of a voice command based on the detected gesture sequence and the gesture sequence data maintained in the cloud-based data repository.

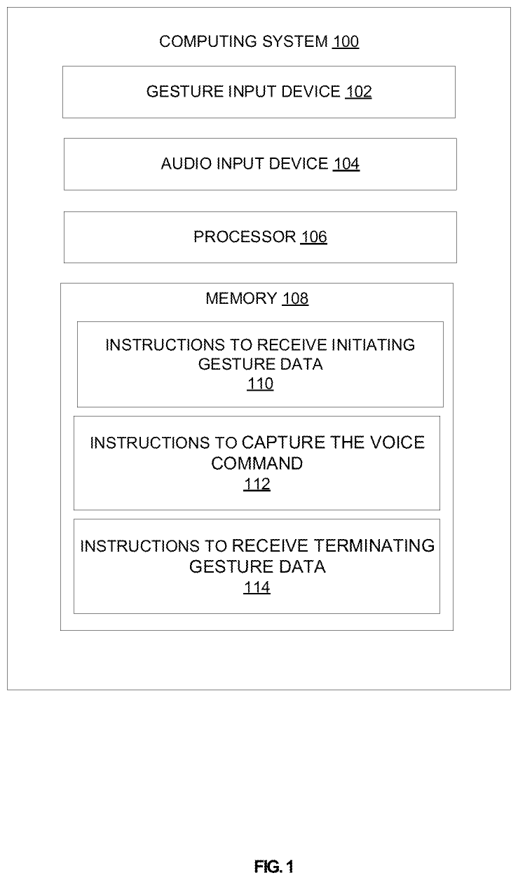

FIG. 1 illustrates a block diagram of computing system 100 having instructions for initiating a voice command based on a gesture, according to an example. Computing system 100 depicts gesture input device 102, audio input device 104, processor 106, and memory 108. As an example of computing system 100 performing its operations, memory 108 may include instructions 110-114 that are executable by processor 106. Thus, memory 108 can be said to store program instructions that, when executed by processor 106, implement the components of computing system 100.

In particular, the executable instructions stored in memory 108 include, as an example, instructions 110 to receive initiating gesture data performed by a user and instructions 112 to capture the voice command. The executable instructions stored in memory 108 also include, as an example, instructions 114 to receive terminating gesture data.

Instructions 110 to receive initiating gesture data represent program instructions that, when executed by processor 106, cause computing system 100 to receive, by the gesture input device, initiating gesture data performed by a user which indicates an initiation of a voice command. The gesture data may include information indicating a shape, pose, or movement associated with part(s) of a user's body. Such a gesture may be as simple as a stationary pose or a straight-line movement or as complicated as a series of movements or poses.

The gesture may be input by a device which observes the body of the user or a motion detection device which communicates a motion of the user. For example, gesture input device 102 may comprise at least one of a camera, a depth sensor, and a motion sensor. The camera may include a Red, Green, Blue (RGB) camera, a Black and White (B/W) camera, an Infrared (IR) camera, or some other image device which can detect a gesture. In other examples, gesture input device 102 may be a mouse, stylus, gaming controller, or any other hand-held device capable of detecting a motion of the user. It should be noted that gestures can be recognized with varying degrees of accuracy with any of the above referenced gesture input devices. In some examples, maintain the initiating gesture data and the terminating gesture data in a cloud-based data repository to be ingested by a machine learning computing system.

Instructions 112 to capture the voice command represent program instructions that when executed by processor 106 cause computing system 100 to capture, by the audio input device, the voice command spoken the user. In some examples, the gesture is detected during execution of a conferencing application. For example, the user may be participating in an internet call (e.g., a conference call) when they would like to initiate the voice command. In this example, the internet call audio is muted in response to receiving the initiating gesture data performed by the user which indicates the initiation of the voice command. Furthermore, the internet call audio may be unmuted in response to receiving the terminating gesture data performed by the user which indicates a termination of the voice command.

Instructions 114 to receive terminating gesture data represent program instructions that, when executed by processor 106, cause computing system 100 to receive, by the gesture input device, terminating gesture data performed by the user which indicates a termination of the voice command.

In some examples, the terminating gesture data comprises a release of a gesture associated with the initiating gesture data. For example, the initiating gesture data may be a raised arm and the terminating gesture data may be the release of the raised arm. In other examples, the initiating gesture data and the terminating gesture data comprise a sequence of gestures performed by the user. In yet another example, the initiating gesture data and the terminating gesture data comprise a velocity of a gesture performed by the user. For example, the user may initiate the voice command by waving a hand at a rapid pace. Once the user is done using the voice commands, the user may then wave again. In other examples, the initiating gesture data and the terminating gesture data may comprise a depth of a gesture performed by the user. For example, the user may lean in toward gesture input device 102 to initiate the voice commands. Once the user is done using the voice commands, the user may lean away from gesture input device 102.

Computing system 100 may represent any device capable running and executing applications locally or exchanging wireless communication with another electronic device running and executing application in a cloud-based environment. For example, computing system 100 may include a laptop computer, desktop computer, all-on-one (AIO) computer, tablet, phone, etc.

Memory 108 represents any number of memory components capable of storing instructions that can be executed by processor 106. As a result, memory 108 may be implemented in a single device or distributed across devices. Likewise, processor 106 represents any number of processors capable of executing instructions stored by memory 108.

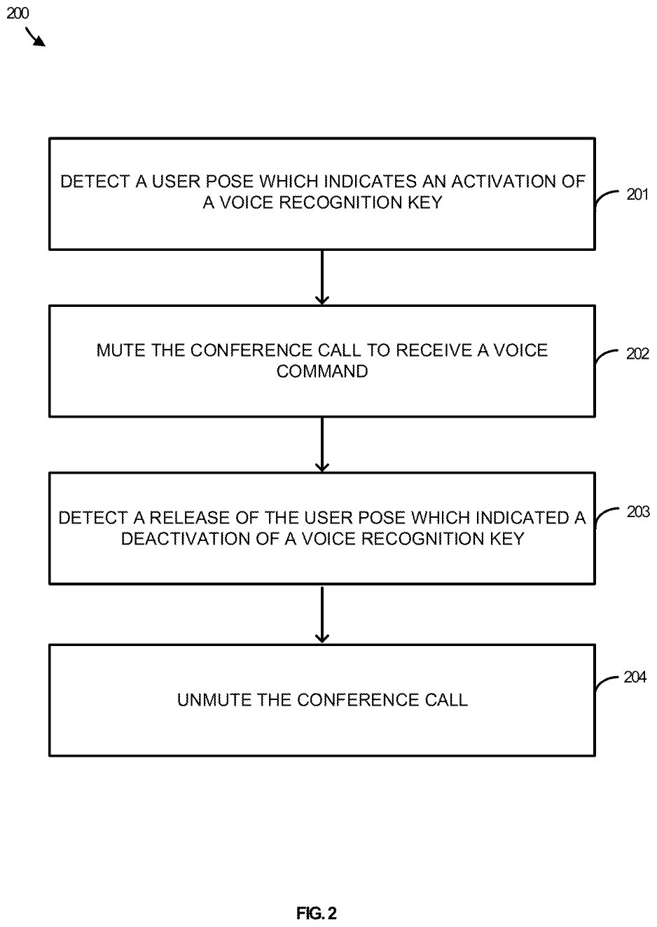

FIG. 2 illustrates a flow diagram of method 200 to operate an internet call computing system, according to an example. Some or all of the steps of method 200 may be implemented in program instructions in the context of a component or components of an application used to carry out the gesture voice initiation gesture. Although the flow diagram of FIG. 2 shows a specific order of execution, the order of execution may differ from that which is depicted. For example, the order of execution of two of more blocks shown in succession by be executed concurrently or with partial concurrence. All such variations are within the scope of the present disclosure.

Referring to the steps in FIG. 2, method 200 detects a user pose which indicates an activation of a voice recognition key, at 201. In some examples, the user pose is detected based on a determination of a distance of an input device from a predetermined location. In other examples, the user pose is detected by a movement of a mouse or stylus.

For example, the user may place a hand on their chest to indicate that the user would like to use a voice command. The pose may be detected by a camera, motion detection device, or depth perception device. For example, the user may lift the mouse and place the mouse on their chest. In other examples, an IR camera may detect that the user has placed their hand on their chest.

In response to detecting the user pose, method 200 mutes the internet call to receive a voice command, at 202. For example, a user may be on a conference call when they decide to initiate the voice commands. However, the user may not want to interrupt the call or allow the other users on the conference call to hear that the user is initiating the voice commands. The user may also not want to have to click on the screen or keyboard to activate the voice command feature. Therefore, the user can use the gesture to initiate the voice command and in response, the conference call may be muted. The user would then be able to provide the voice commands to navigate or control an application.

Method 200 detects a release of the user pose which indicated a deactivation of a voice recognition key, at 203. For example, once the user has finished using voice commands to control the application, the user would then take their arm off of their chest. In response to detecting the release of the user pose, method 200 unmutes the internet call, at 204.

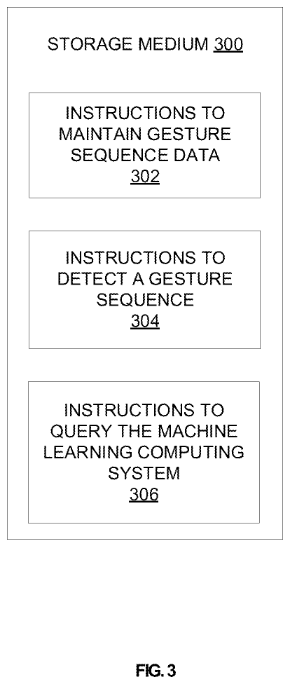

FIG. 3 illustrates a block diagram of non-transitory storage medium 300 storing machine-readable instructions that upon execution cause a system to receive a voice command based on gesture data, according to an example. Storage medium is non-transitory in the sense that is does not encompass a transitory signal but instead is made up of a memory component configured to store the relevant instructions.

The machine-readable instructions include instructions 302 to maintain gesture sequence data in a cloud-based data repository to be ingested by a machine learning computing system. The machine-readable instructions also include instructions 304 to detect a gesture sequence. The machine-readable instructions also include instructions 306 to query the machine learning computing system to determine that that gesture sequence data indicates an initiation of a voice command based on the detected gesture sequence and the gesture sequence data maintained in the cloud-based data repository.

In one example, program instructions 302-306 can be part of an installation package that when installed can be executed by a processor to implement the components of a computing device. In this case, non-transitory storage medium 300 may be a portable medium such as a CD, DVD, or a flash drive. Non-transitory storage medium 300 may also be maintained by a server from which the installation package can be downloaded and installed. In another example, the program instructions may be part of an application or applications already installed. Here, non-transitory storage medium 300 can include integrated memory, such as a hard drive, solid state drive, and the like.

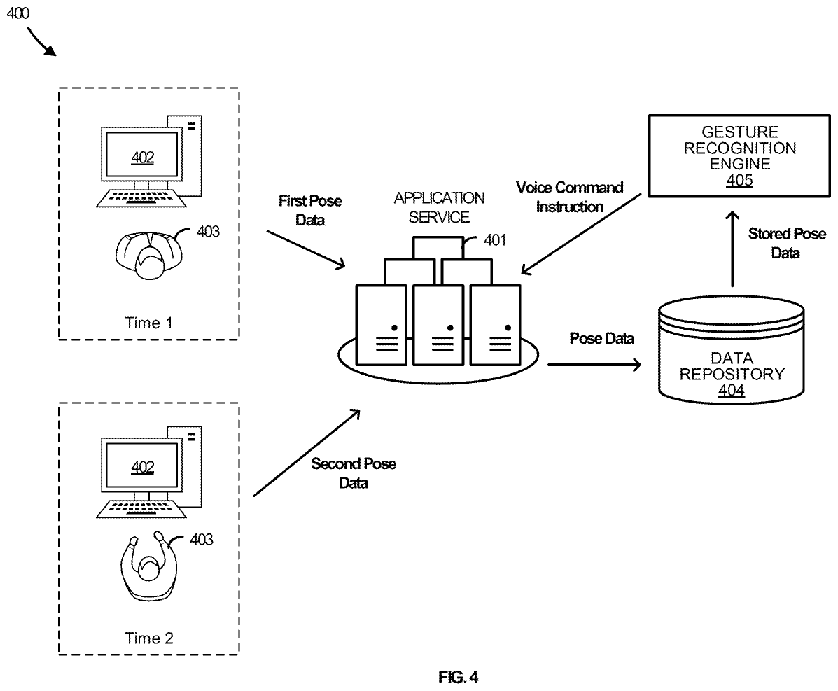

FIG. 4 illustrates an operational architecture of a system for initiating a voice command based on a user gesture, according to another example. FIG. 4 illustrates operational scenario 400 that relates to what occurs when pose data is stored in a data repository and the voice command instruction is generated using machine learning algorithms or techniques in a gesture recognition engine. Operational scenario 400 includes application service 401, computing device 402, user 403, data repository 404, and gesture recognition engine 405.

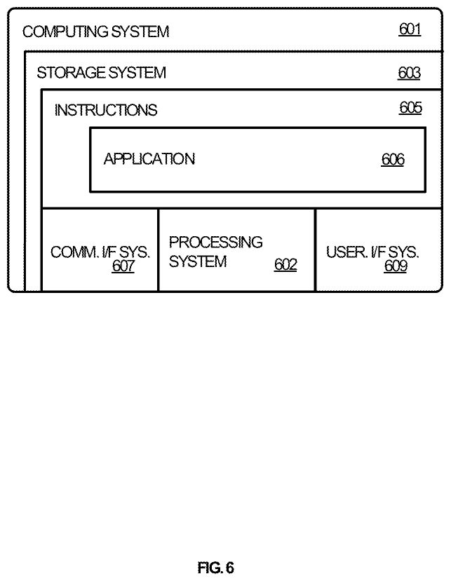

Application service 401 is representative of any device capable of running an application natively or in the context of a web browser, streaming an application, or executing an application in any other manner. Examples of application service 401 include, but are not limited to, personal computers, mobile phones, tablet computers, desktop computers, laptop computers, wearable computing devices, or any other form factor, including any combination of computers or variations thereof. Application service 401 may include various hardware and software elements in a supporting architecture suitable for performing process 500. One such representative architecture is illustrated in FIG. 6 with respect to computing system 601.

Application service 401 also includes a software application or application component capable of generating a voice command instruction in accordance with the processes described herein. The software application may be implemented as a natively installed and executed application, a web application hosted in the context of a browser, a streamed or streaming application, a mobile application, or any variation or combination thereof.

As shown in FIG. 4, at time 1, computing device 402 may transfer first pose data to application service 401. At time 2, computing device 402 may transfer second pose data to application service 401. Examples of client devices include any or some combination of the following: a desktop computer, a notebook computer, a tablet computer, a smartphone, a game appliance, a wearable device (e.g., a smart watch, a head-mount device, etc.), or any other type of electronic device. Application service 401 may then transfer the first pose data for computing device 402 to data repository 404.

Data repository 404 may be any data structure (e.g., a database, such as a relational database, non-relational database, graph database, etc.), a file, a table, or any other structure which may store a collection of data. Based on the data stored in data repository 404, gesture recognition engine 405 is able to generate voice command instructions based on the recognized gesture.

In response to the first pose data and the second pose data being received from computing device 402 via application service 401, gesture recognition engine 405 processes the received gesture data from application service 401 and the stored pose data from data repository 404. Gesture recognition engine 405 may be a rule-based engine which may process a selection of poses and combinations of poses to determine a gesture which indicates an initiation of a voice command. Gesture recognition engine 405 may further include a data filtration system which filters the selected poses to determine data which will be used in generating the voice command instruction. In some examples, gesture recognition engine 405 may use a statistical supervised model to filter the data and generate the voice command instruction. The voice command instruction is then communicated to computing device 402 via application service 401.

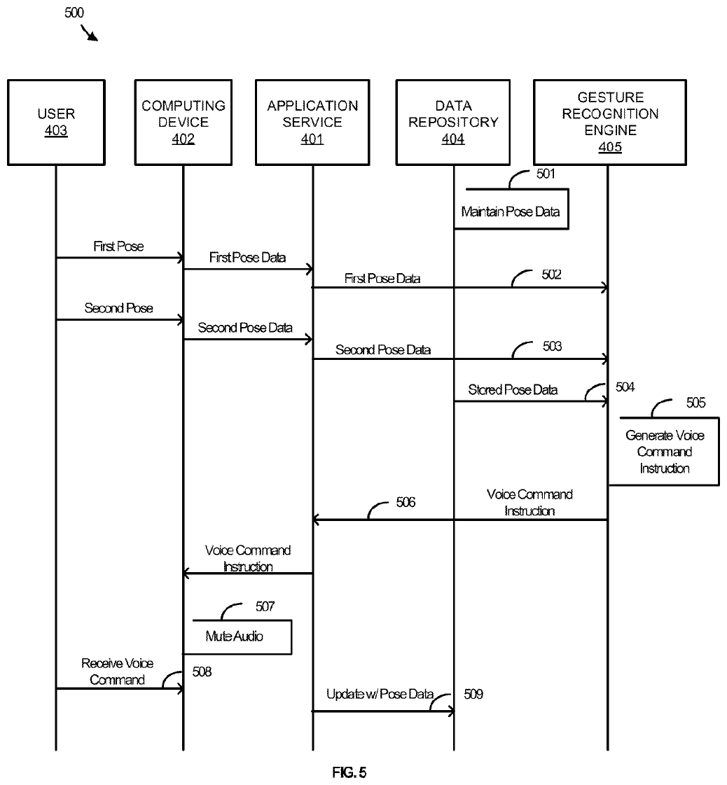

FIG. 5 illustrates a sequence diagram for process 500 to generate a voice command instruction based on a user gesture, according to another example. Specifically, the sequence diagram illustrates an operation of system 400 to generate a voice command instruction based on the gesture performed by user 403 using gesture data stored in a data repository and processed using machine learning techniques in a gesture recognition engine.

In a first step, data repository 404 collects and maintains stored pose data, at 501. At time 1, computing device 402 receives the first pose data indicating a first gesture made by user 403 and transfers the first pose data to gesture recognition engine over application service 401, at 502. At time 2, computing device 402 receives the second pose data indicating the second user pose and transfers the second pose data to gesture recognition engine 405 over application service 401, at 503. In this example scenario, the user's arms are raised and located closer to computing device 402.

In a next step, the stored pose data is retrieved from data repository 404 and transferred to gesture recognition engine 405 to be processed with the first pose data and the second pose data using machine learning techniques, 504. Gesture recognition engine 405 then processes the first pose data, the second pose data, and the stored pose data to recognize a gesture and determine a voice command instruction, at 505. Once the voice command instruction has been determined, the voice command instruction is transferred to application service 401, and application service 401 in turn transfers the voice command instruction to computing device 402, at 506. In response to receiving the voice command instruction, computing device 402 mutes audio and receives a voice command (at 508). In a final operation, data repository 404 is updated with the first and second pose data indicating the recognized gesture, at 509.

FIG. 6 illustrates computing system 601, which is representative of any system or visual representation of systems in which the various applications, services, scenarios, and processes disclosed herein may be implemented. Examples of computing system 601 include, but are not limited to, server computers, rack servers, web servers, cloud computing platforms, and data center equipment, as well as any other type of physical or virtual server machine, container, and any variation or combination thereof. Other examples may include smart phones, laptop computers, tablet computers, desktop computers, hybrid computers, gaming machines, virtual reality devices, smart televisions, smart watches and other wearable devices, as well as any variation or combination thereof.

Computing system 601 may be implemented as a single apparatus, system, or device or may be implemented in a distributed manner as multiple apparatuses, systems, or devices. Computing system 601 includes, but is not limited to, processing system 602, storage system 603, instructions 605, communication interface system 607, and user interface system 609. Processing system 602 is operatively coupled with storage system 603, communication interface system 607, and user interface system 609.

Processing system 602 loads and executes instructions 605 from storage system 603. Instructions 605 includes application 606, which is representative of the processes discussed with respect to the preceding FIGS. 1-5, including method 200. When executed by processing system 602 to enhance an application, instructions 605 directs processing system 602 to operate as described herein for at least the various processes, operational scenarios, and sequences discussed in the foregoing examples. Computing system 601 may optionally include additional devices, features, or functionality not discussed for purposes of brevity.

Referring still to FIG. 6, processing system 602 may comprise a micro-processor and other circuitry that retrieves and executes instructions 605 from storage system 603. Processing system 602 may be implemented within a single processing device but may also be distributed across multiple processing devices or sub-systems that cooperate in executing program instructions. Examples of processing system 602 include general purpose central processing units, graphical processing unites, application specific processors, and logic devices, as well as any other type of processing device, combination, or variation.

Storage system 603 may comprise any computer readable storage media readable by processing system 602 and capable of storing instructions 605. Storage system 603 may include volatile and nonvolatile, removable and non-removable media implemented in any method or technology for storage of information, such as computer readable instructions, data structures, program modules, or other data. Examples of storage media include random access memory, read only memory, magnetic disks, optical disks, flash memory, virtual memory and non-virtual memory, magnetic cassettes, magnetic tape, magnetic disk storage or other magnetic storage devices, or other suitable storage media, except for propagated signals. Storage system 603 may be implemented as a single storage device but may also be implemented across multiple storage devices or sub-systems co-located or distributed relative to each other. Storage system 603 may comprise additional elements, such as a controller, capable of communicating with processing system 602 or possibly other systems.

Instructions 605 may be implemented in program instructions and among other functions may, when executed by processing system 602, direct processing system 602 to operate as described with respect to the various operational scenarios, sequences, and processes illustrated herein. Instructions 605 may include program instructions for implementing method 200.

In particular, the program instructions may include various components or modules that cooperate or otherwise interact to carry out the various processes and operational scenarios described herein. The various components or modules may be embodied in compiled or interpreted instructions, or in some other variation or combination of instructions. The various components or modules may be executed in a synchronous or asynchronous manner, serially or in parallel, in a single threaded environment or multi-threaded, or in accordance with any other suitable execution paradigm, variation, or combination thereof. Instructions 605 may include additional processes, programs, or components, such as operating system software, virtual machine software, or other application software, in addition to or that include process 606. Instructions 605 may also comprise firmware or some other form of machine-readable processing instructions executable by processing system 602.

In general, instructions 605 may, when loaded into processing system 602 and executed, transform a suitable apparatus, system, or device (of which computing system 601 is representative) overall from a general-purpose computing system into a special-purpose computing system. Indeed, encoding instructions 605 on storage system 603 may transform the physical structure of storage system 603. The specific transformation of the physical structure may depend on various factors in different examples of this description. Such factors may include, but are not limited to, the technology used to implement the storage media of storage system 603 and whether the computer-storage media are characterized as primary or secondary storage, as well as other factors.

If the computer readable storage media are implemented as semiconductor-based memory, instructions 605 may transform the physical state of the semiconductor memory when the program instructions are encoded therein, such as by transforming the state of transistors, capacitors, or other discrete circuit elements constituting the semiconductor memory. A similar transformation may occur with respect to magnetic or optical media. Other transformations of physical media are possible without departing from the scope of the present description, with the foregoing examples provided only to facilitate the present discussion.

Communication interface system 607 may include communication connections and devices that allow for communication with other computing systems (not shown) over communication networks (not shown). Examples of connections and devices that together allow for inter-system communication may include network interface cards, antennas, power amplifiers, RF circuitry, transceivers, and other communication circuitry. The connections and devices may communicate over communication media to exchange communications with other computing systems or networks of systems, such as metal, glass, air, or any other suitable communication media. The aforementioned media, connections, and devices are well known and need not be discussed at length here.

User interface system 609 may include a keyboard, a mouse, a voice input device, a touch input device for receiving a touch gesture from a user, a motion input device for detecting non-touch gestures and other motions by a user, and other comparable input devices and associated processing elements capable of receiving user input from a user. Output devices such as a display, speakers, haptic devices, and other types of output devices may also be included in user interface system 609. In some cases, the input and output devices may be combined in a single device, such as a display capable of displaying images and receiving touch gestures. The aforementioned user input and output devices are well known in the art and need not be discussed at length here. User interface system 609 may also include associated user interface software executable by processing system 602 in support of the various user input and output devices discussed above.

Communication between computing system 601 and other computing systems (not shown), may occur over a communication network or networks and in accordance with various communication protocols, combinations of protocols, or variations thereof. Examples include intranets, internets, the Internet, local area networks, wide area networks, wireless networks, wired networks, virtual networks, software defined networks, data center buses, computing backplanes, or any other type of network, combination of network, or variation thereof. The aforementioned communication networks and protocols are well known and need not be discussed at length here.

Certain inventive aspects may be appreciated from the foregoing disclosure, of which the following are various examples.

The functional block diagrams, operational scenarios and sequences, and flow diagrams provided in the FIGS. are representative of example systems, environments, and methodologies for performing novel aspects of the disclosure. While, for purposes of simplicity of explanation, methods included herein may be in the form of a functional diagram, operational scenario or sequence, or flow diagram, and may be described as a series of acts, it is to be understood and appreciated that the methods are not limited by the order of acts, as some acts may, in accordance therewith, occur in a different order and/or concurrently with other acts from that shown and described herein. It should be noted that a method could alternatively be represented as a series of interrelated states or events, such as in a state diagram. Moreover, not all acts illustrated in a methodology may be required for a novel example.

It is appreciated that examples described may include various components and features. It is also appreciated that numerous specific details are set forth to provide a thorough understanding of the examples. However, it is appreciated that the examples may be practiced without limitations to these specific details. In other instances, well known methods and structures may not be described in detail to avoid unnecessarily obscuring the description of the examples. Also, the examples may be used in combination with each other.

Reference in the specification to “an example” or similar language means that a particular feature, structure, or characteristic described in connection with the example is included in at least one example, but not necessarily in other examples. The various instances of the phrase “in one example” or similar phrases in various places in the specification are not necessarily all referring to the same example.

1. A computing system comprising:
a gesture input device;
an audio input device; and
a processor communicatively coupled to the gesture input device and the audio input device, the processor to:
receive, by the gesture input device, initiating gesture data performed by a user which indicates an initiation of a voice command;
capture, by the audio input device, the voice command spoken the user; and
receive, by the gesture input device, terminating gesture data performed by the user which indicates a termination of the voice command.

2. The computing system of claim 1 wherein the terminating gesture data comprises a release of a gesture associated with the initiating gesture data.

3. The computing system of claim 1 wherein the initiating gesture data and the terminating gesture data comprises a sequence of gestures performed by the user.

4. The computing system of claim 1 wherein the initiating gesture data and the terminating gesture data comprises a velocity of a gesture performed by the user.

5. The computing system of claim 1 wherein the initiating gesture data and the terminating gesture data comprises a depth of a gesture performed by the user.

6. The computing system of claim 1 wherein the gesture is detected during execution of a conferencing application.

7. The computing system of claim 6 wherein the internet call audio is muted in response to receiving the initiating gesture data performed by the user which indicates the initiation of the voice command.

8. The computing system of claim 7 wherein the internet call audio is unmuted in response to receiving the terminating gesture data performed by the user which indicates a termination of the voice command.

9. The computing system of claim 1 wherein the gesture input device comprises at least one of a camera, a depth sensor, and a motion sensor.

10. The computing system of claim 1 further comprising the processor to maintain the initiating gesture data and the terminating gesture data in a cloud-based data repository to be ingested by a machine learning computing system.

11. A method of operating an internet call computing system comprising:
detecting a user pose which indicates an activation of a voice recognition key;
in response to detecting the user pose, muting the internet call to receive a voice command;
detecting a release of the user pose which indicated a deactivation of a voice recognition key; and
in response to detecting the release of the user pose, unmuting the internet call.

12. The method of claim 11 wherein the user pose is detected based on a determination of a distance of an input device from a predetermined location.

13. The method of claim 11 wherein the user pose is detected by a movement of a mouse or stylus.

14. A non-transitory computer readable medium comprising program instructions executable by a processor to:
maintain gesture sequence data in a cloud-based data repository to be ingested by a machine learning computing system;
detect a gesture sequence; and
query the machine learning computing system to determine that that gesture sequence data indicates an initiation of a voice command based on the detected gesture sequence and the gesture sequence data maintained in the cloud-based data repository.

15. The non-transitory computer readable medium of claim 14 wherein the cloud-based data repository is updated with the detected gesture sequence.
